(19) United States
(12) Patent Application Publication
(10) Pub. No.: US 2014/0251236 A1
(43) Pub. Date: Sep. 11, 2014

(54) HYDROGENATION SYSTEM FOR INTERNAL COMBUSTION ENGINE

(71) Applicant: PROMETHEUS ENERGY TECHNOLOGY CO., Taipei (TW)

(72) Inventors: Hui-Wen FENG, Taipei (TW); Yaw-Chung CHENG, Taipei (TW)

(73) Assignee: PROMETHEUS ENERGY TECHNOLOGY CO., Taipei (TW)

(21) Appl. No.: 13/786,659

(22) Filed: Mar. 6, 2013

(51) Int. Cl. F02B 43/08

(52) U.S. Cl. CPC F02B 43/08
USPC 123/3

(57) ABSTRACT

A hydrogenation system is disclosed for controlling the air-fuel ratio in an internal combustion engine and using engine waste heat to produce hydrogen for supplying into the engine to achieve the purposes of reducing air pollution and saving fuel; and includes a fuel-water solution supply unit, a catalytic converter, a first temperature detecting switch, a fuel supply control unit, a coolant supply unit and a second temperature detecting switch. When the first temperature detecting switch detects the catalytic converter has reached a working temperature for producing hydrogen, an amount of fuel-water solution is supplied to the catalytic converter and subjected to molecular rearrangement for producing hydrogen gas, which is sent into the engine to burn along with fuel. When the second temperature detecting switch detects the catalytic converter has reached a safe temperature, coolant is supplied from the coolant supply unit to the catalytic converter to lower the latter's temperature.

### FIELD OF THE INVENTION

The present invention relates to a hydrogenation system for internal combustion engine, and more particularly to a hydrogenation system that is provided directly on an engine body for producing hydrogen gas and controlling the timing of delivering the produced hydrogen gas into the engine to fully achieve the purposes of saving fuel and reducing air pollution.

### BACKGROUND OF THE INVENTION

Cars are traffic means that highly relay on petroleum fuel and accordingly main sources of greenhouse gas emission. Therefore, car carbon reduction and energy saving has become an important policy in many countries.

To achieve good ignition and combustion efficiency of fuel, the internal combustion engine for a car is generally set to its optimal air-fuel ratio (AFR) in the car plant. Usually, the optimal AFR, or briefly referred to as “Value A”, is between 14.5:1 and 15.0:1, helps in obtaining the maximum combustion efficiency of fuel in the engine. Many internationally famous car manufacturers use high-precision control systems in the production of fuel-saving cars to set the air-fuel ratio close to the Value A in mixing fuel with air.

The higher AFR indicates less fuel is contained in the air-fuel mixture to achieve the purpose of fuel saving. However, the higher AFR tends to cause unstable engine operation and engine knocking as well as insufficient horsepower. In the case of having an AFR larger than the Value A, it means the fuel in the engine is relatively lean. Under this condition, lean combustion in the engine after ignition will occur. The lean combustion will cause lag explosion and accordingly, detonation in the engine, resulting in unsmooth engine operation. When the detonation in engine occurs, the car will vibrate violently to have lowered engine efficiency and the risk of a stalled engine. Further, both the car body and in-car systems are subjected to damage due to the engine detonation.

Fuel supplied from a fuel tank and air fed in via an intake manifold are mixed with each other before the fuel-air mixture enters the engine and is ignited to burn, explode, and push the piston in the engine to work. During the process of burning, about ⅓ of the fuel is not completely burned but is discharged along with exhaust gas via an exhaust pipe to cause air pollution. When the AFR is too low, incomplete combustion of fuel tends to occur to thereby produce high pollution-causing exhaust emission, which will badly affect the quality of ambient air to endanger the environmental protection. Since hydrogen has a relative low energy level of 0.017MJ compared to the gasoline's energy level of 0.29MJ, it can burn quickly with a flame speed of 3.2-4.4M/s, which is much faster than the flame speed of 0.34M/s of gasoline. Therefore, the fuel's combustion efficiency in engine can be upgraded by burning hydrogen in the engine. With the increased fuel combustion efficiency, the fuel that was originally not able to burn completely can be now completely burned instantaneously without causing engine detonation. Under this condition, the carbon content in the exhaust emission is reduced to minimize air pollution. In other words, the present invention utilizes hydrogen fuel to assist in the upgrading of the efficiency of petroleum energy and the purifying of the exhaust emission, so as to reduce the consumption of fuel and the greenhouse gas emission. However, it is uneasy to continuously supply safe and economical hydrogen gas to cars that keep moving on roads.

It is therefore tried by the inventor to develop a hydrogenation system for internal combustion engine, which can control the timing of supplying a fuel-water solution to a catalytic converter for producing hydrogen gas and deliver the produced hydrogen gas into an engine to complete a hydrogenation process, so as to achieve the purposes of saving fuel and reducing air pollution in the modern society that encounters the depletion of energy sources and the increasingly enhanced sense of environmental protection.

### SUMMARY OF THE INVENTION

A primary object of the present invention is to provide a hydrogenation system for internal combustion engine, which uses engine waste heat as a heat source for a catalytic converter to produce hydrogen gas, so as to save the energy needed in producing hydrogen gas and assist in the complete combustion of fuel in the internal combustion engine to thereby achieve the purposes of reducing carbon in the exhaust emission and avoiding air pollution.

Another object of the present invention is to provide a hydrogenation system for internal combustion engine, which controls the timing of delivering hydrogen gas into the engine and the amount of hydrogen gas to be delivered, so as to improve the problem of detonation and unsmooth operation in the internal combustion engine due to lean combustion while achieve the purpose of saving fuel.

A further object of the present invention is to provide a hydrogenation system for internal combustion engine, which controls the amount of hydrogen gas delivered into the engine from a catalytic converter and the amount of fuel supplied into the engine via a throttle to thereby achieve the purpose of saving fuel and hydrogen-producing fuel-water solution at the same time.

To achieve the above and other objects, the hydrogenation system for internal combustion engine according to the present invention includes a fuel-water solution supply unit, a catalytic converter, a first temperature detecting switch, a fuel supply control unit, a coolant supply unit, and a second temperature detecting switch 6. The fuel-water solution supply unit includes a tank, a first liquid pump and a conveying pipeline. The tank stores an amount of fuel-water solution therein and the stored fuel-water solution is pumped out from the tank by the first liquid pump to flow through the conveying pipeline into the catalytic converter. The catalytic converter is arranged inside an exhaust pipe of the internal combustion engine to absorb the heat in the engine's exhaust. The catalytic converter is communicable with the conveying pipeline of the fuel-water solution supply unit and includes a catalyst bed and a preheating body. The catalyst bed is internally provided with molecular rearrangement ducts and cooling ducts. In the molecular rearrangement ducts, there are provided hydrogen-producing catalysts for rearranging the molecules in the fuel-water solution to thereby produce gas-phase hydrogen and carbon dioxide. The first temperature detecting switch detects a temperature of the catalytic converter and actuates the first liquid pump when the catalytic converter is detected as having a temperature reaching the working temperature of the hydrogen-producing catalysts, so that the fuel-water solution is supplied into the catalytic converter for producing hydrogen gas and the produced hydrogen gas flows through an engine intake manifold into the engine and is then burned along with a fuel in the engine when the latter is ignited.

The fuel supply control unit includes two fuel feed pipes for supplying the fuel into the engine. When the first liquid pump is actuated, one of the two fuel feed pipes is closed to reduce the amount of fed fuel, so that the fuel and air in the engine have a lowered fuel-to-air ratio.

The fuel-water solution supply unit further includes a supply control section, which can control the amount of the fuel-water solution supplied to the catalytic converter while a throttle controls the amount of fuel entering the engine, so that the amount of hydrogen and the amount of fuel in the engine match each other.

The coolant supply unit includes a storage tank, a second liquid pump and a coolant conveying pipeline. The second temperature detecting switch detects a temperature of the catalytic converter and actuates the second liquid pump when the catalytic converter is detected as having a temperature reaching a safe temperature of the hydrogen-producing catalysts, so that coolant is delivered into the cooling ducts in the catalyst bed to lower the latter's temperature.

The fuel-water solution is methanol-water solution; and the working temperature and the safe temperature of the catalysts in the catalytic converter are set to 220° C. and 280° C., respectively.

The fuel-water solution supply unit includes a liquid level detecting switch. An actuating circuit for the first liquid pump is cut off when the liquid level detecting switch detects that the methanol-water solution in the tank is insufficient.

The hydrogenation system for internal combustion engine further includes a lubricant adding unit, which includes a lubricant tank, a lubricant conveying pipeline, and a normally closed third solenoid valve provided on the conveying pipeline. When the actuating circuit for the first liquid pump is made, the third solenoid valve is periodically actuated, so that lubricant is output from the lubricant tank into the engine via the lubricant conveying pipeline at regular intervals and in fixed quantity.

The preheating body of the catalytic converter can heat and vaporize the fuel-water solution to steam.

In an embodiment of the present invention, the catalytic converter further includes a heating pipe and a plurality of heating catalysts provided in the heating pipe. The heating pipe is externally fitted around the preheating body and the catalyst bed with the heating catalysts filled between the heating pipe and the preheating body and the catalyst bed. The heating pipe has two sealed ends and is communicable with a combustion gas tank via an inlet pipe connected to one end of the heating pipe, so that a type of oxygen-containing combustion gas can be supplied from the combustion gas tank into the heating pipe via the inlet pipe for heating the heating catalysts, which in turn heat the catalyst bed and the preheating body to the working temperature of the hydrogen-producing catalysts. The other end of the heating pipe is provided with pressure relief vents.

The oxygen-containing combustion gas is supplied from the combustion gas tank into the heating pipe by an air pump. And, the air pump stops supplying the oxygen-containing combustion gas when the catalyst bed is heated by the heating catalysts in the heating pipe to the working temperature of the hydrogen-producing catalysts.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual diagram illustrating the structure of a hydrogenation system for internal combustion engine according to a first preferred embodiment of the present invention;

FIG. 2 is a block diagram showing a circuit structure included in the hydrogenation system of FIG. 1;

FIG. 3 is an enlarged, fragmentary and partial sectional view of FIG. 1 showing the installation of a catalytic converter in an exhaust pipe according to the hydrogenation system of the present invention;

FIG. 4 is a front view of the catalytic converter of FIG. 3;

FIG. 5 is a sectional view taken along line A-A of FIG. 4;

FIG. 6 is a sectional view taken along line B-B of FIG. 4;

FIG. 7 is a block diagram showing the circuit structure included in the hydrogenation system according to a second preferred embodiment of the present invention, in which a differently structured fuel-water solution supply control section is shown;

FIG. 8 is a conceptual diagram illustrating the structure of the hydrogenation system for internal combustion engine according to the second preferred embodiment of the present invention, which has the circuit structure shown in FIG. 7;

FIG. 9 is a conceptual diagram illustrating the structure of the hydrogenation system for internal combustion engine according to a third preferred embodiment of the present invention;

FIG. 10 is a block diagram showing the circuit structure included in the hydrogenation system according to the third preferred embodiment of the present invention;

FIG. 11 is an enlarged, fragmentary and partial sectional view of FIG. 9 showing the installation of the catalytic converter in the exhaust pipe according to the third preferred embodiment of the hydrogenation system of the present invention; and

FIG. 12 is an enlarged sectional view of the catalytic converter of FIG. 11.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

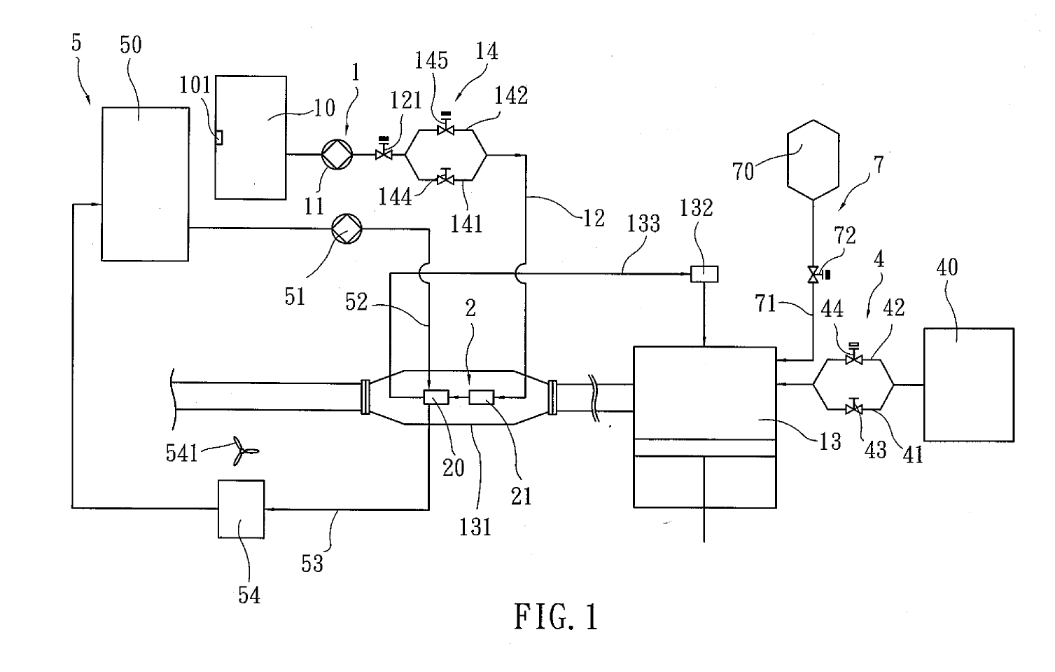

The present invention provides a hydrogenation system for internal combustion engine. For the purpose of conciseness and clarity, the present invention is also briefly referred to as the hydrogenation system herein and the internal combustion engine is also briefly referred to as the engine. Please refer to FIGS. 1 to 3. The hydrogenation system according to a first preferred embodiment of the present invention mainly includes a fuel-water solution supply unit 1, a catalytic converter 2, a first temperature detecting switch 3, a fuel supply control unit 4, a coolant supply unit 5, and a second temperature detecting switch 6.

The fuel-water solution supply unit 1 includes a tank 10, a first liquid pump 11, and a conveying pipeline 12. The tank 10 stores an amount of fuel-water solution therein and the stored fuel-water solution is pumped out from the tank 10 by the first liquid pump 11 to flow through the conveying pipeline 12 into the catalytic converter 2.

The catalytic converter 2 is arranged inside an exhaust pipe 131 of an engine 13 to absorb heat in the engine's exhaust gas for using as heat energy in producing hydrogen. The catalytic converter 2 is communicable with the conveying pipeline 12 of the fuel-water solution supply unit 1. That is, in the hydrogenation system of the present invention, the first liquid pump 11 is actuated under control to pump out the fuel-water solution from the tank 10 into the catalytic converter 2, at where hydrogen gas is produced and then sent via an intake manifold 132 into the engine 13 for burning along with a fuel after ignition of the engine 13.

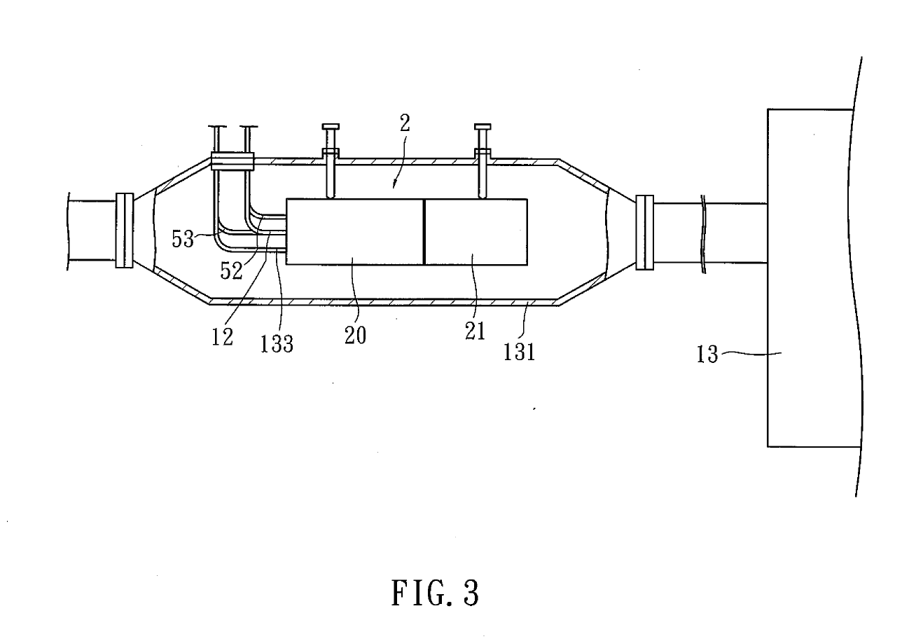

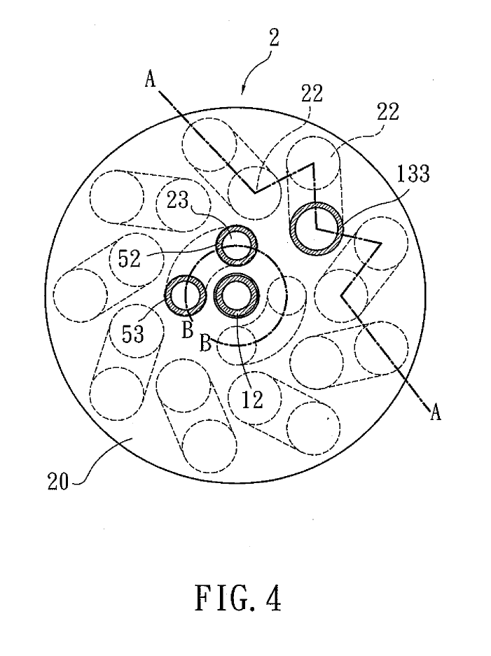

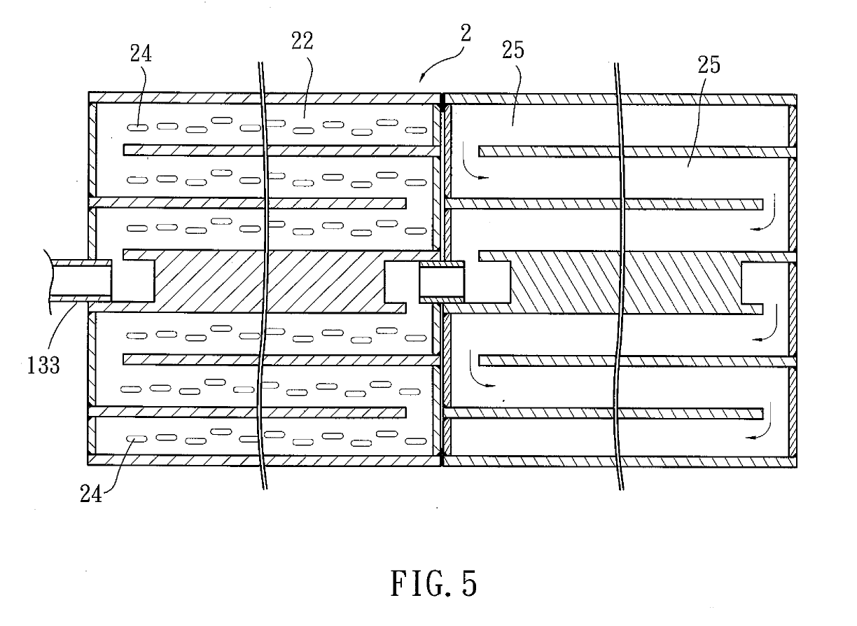

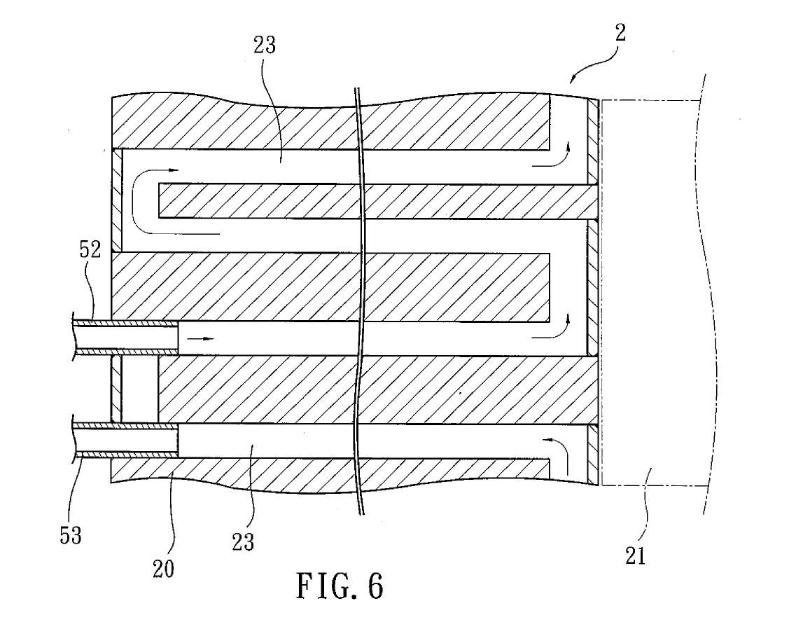

Please refer to FIGS. 3 to 6. The catalytic converter 2 includes a catalyst bed 20 and a preheating body 21. The catalyst bed 20 is internally provided with molecular rearrangement ducts 22 and cooling ducts 23. In the molecular rearrangement ducts 22, there are provided hydrogen-producing catalysts 24 for rearranging the molecules in the fuel-water solution to produce hydrogen gas and carbon dioxide gas. The fuel-water solution flows through the conveying pipeline 12 into the preheating body 21 and is vaporized into gas phase before being sent into the catalyst bed 20 for molecular rearrangement to produce the hydrogen gas and carbon dioxide gas. The preheating body 21 is internally provided with preheating pipelines 25, which have an end communicating with the conveying pipeline 12 of the fuel-water solution supply unit 1 and another opposite end communicating with the molecular rearrangement ducts 22.

When the first temperature detecting switch 3 detects the catalytic converter 2 has a temperature reaching a working temperature of the hydrogen-producing catalysts 24, the first liquid pump 11 is actuated to deliver the fuel-water solution into the catalytic converter 2 for producing hydrogen gas. The produced hydrogen gas flows through a hydrogen gas pipeline 133 to the intake manifold 132 of the engine 13 before entering the engine 13. The hydrogen gas is then burned along with the fuel in the engine 13 when the latter is ignited.

The fuel supply control unit 4 includes two fuel feed pipes 41, 42 for supplying fuel into the engine 13. The first fuel feed pipe 41 is provided with a manual control valve 43, and the second fuel feed pipe 42 is provided with a normally open first solenoid valve 44. The first solenoid valve 44 is actuated when the first liquid pump 11 is actuated, so as to close the second fuel feed pipe 42 and reduce the amount of fed fuel for the fuel and air in the engine 13 to have a lowered fuel-air ratio. In FIG. 1, the reference numeral 40 indicates a fuel tank. The fuel-air ratio can be differently set by regulating the amount of fed fuel via the manual control valve 43 during the hydrogenation process.

The fuel-water solution supply unit 1 further includes a supply control section 14, which can control the amount of the fuel-water solution supplied to the catalytic converter 2 while a throttle 15 controls the amount of fuel entering the engine 13, so that the amount of hydrogen and the amount of fuel in the engine 13 match each other.

In this manner, proper amount of fuel-water solution can be timely supplied for producing hydrogen to enable hydrogenation of fuel in the engine 13 without unnecessary waste of the fuel-water solution. The supply control section 14 includes two feed pipes 141, 142 for delivering the fuel-water solution, and a pressure sensor 143 for detecting the pressure applied to the throttle 15. The first feed pipe 141 is provided with a manual control valve 144 and the second feed pipe 142 is provided with a normally closed second solenoid valve 145. The second solenoid valve 145 is actuated when the pressure sensor 143 detects the throttle 15 is in a stably opened state, so as to open the second feed pipes 142 to increase the amount of fuel-water solution being supplied to the catalytic converter 2. In addition, there is a normally closed fourth solenoid valve 121 provided in the conveying pipeline 12. When the hydrogenation system of the present invention stops operating, the fourth solenoid valve 121 can close the conveying pipeline 12 to prevent the produced hydrogen gas from flowing backward along the conveying pipeline 12.

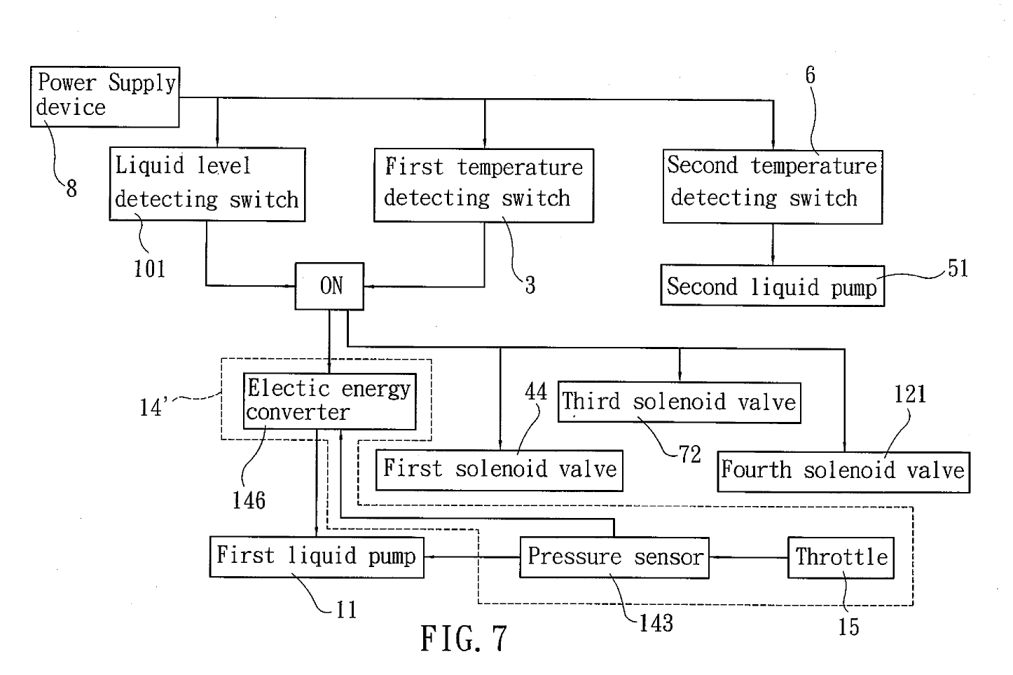

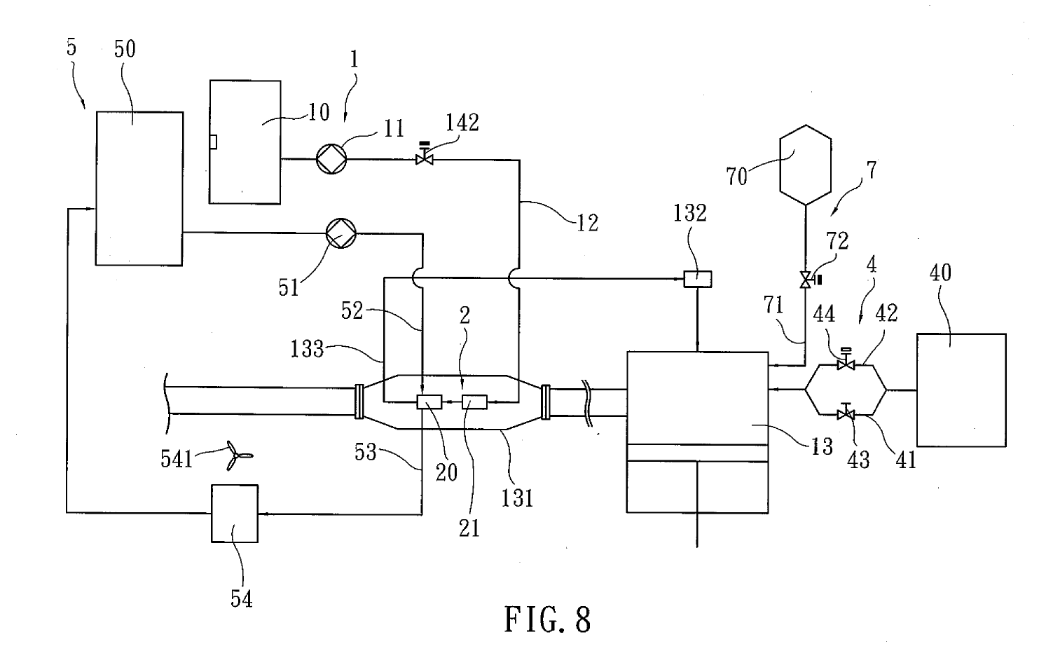

FIG. 7 is a block diagram showing the circuit structure included in the hydrogenation system according to a second preferred embodiment of the present invention, in which a differently structured fuel-water solution supply control section 14′ in the fuel-water solution supply unit 1 is shown; and FIG. 8 is a conceptual diagram illustrating the structure of the hydrogenation system for internal combustion engine according to the second preferred embodiment of the present invention, which has the circuit structure shown in FIG. 7. The supply control section 14′ includes a pressure sensor 143 for detecting the pressure applied to the throttle 15, and an electric energy converter 146. When the pressure sensor 143 detects a different degree to which the throttle 15 is opened, a signal is transmitted to the electric energy converter 146 for the latter to output a different electric energy supply to drive the first liquid pump 11 to supply a different flow of the fuel-water solution. The electric energy converter 146 can be a pulse-width modulator (PWM).

The coolant supply unit 5 includes a storage tank 50, a second liquid pump 51 and a coolant conveying pipeline 52. The storage tank 50 stores an amount of coolant therein and the stored coolant is pumped out from the storage tank 50 by the second liquid pump 51 to flow through the coolant conveying pipeline 52 into the cooling ducts 23 in the catalyst bed 20. A back flow pipeline 53 of the coolant conveying pipeline 52 is provided with a heat-dissipation cooler 54, which exchanges heat with cold ambient air and includes a cooling fan 541.

When the second temperature detecting switch 6 detects the catalytic converter 2 has a temperature reaching a safe temperature of the hydrogen-producing catalysts 24, the second liquid pump 51 is actuated to deliver the coolant into the cooling ducts 23 in the catalyst bed 20 to lower the latter's temperature.

The fuel-water solution can be methanol-water solution. When the catalysts 24 in the catalyst bed 20 reach a temperature between 220 and 330° C., they can rearrange the molecules in the methanol-water solution to produce hydrogen gas. The catalysts 24 can be CuZn-based catalysts. The working temperature of the catalysts 24 can be set to 220° C. Since the catalysts 24 might be burned out at an environment temperature higher than 330° C., the safe temperature for the catalysts 24 can be set to 280° C.

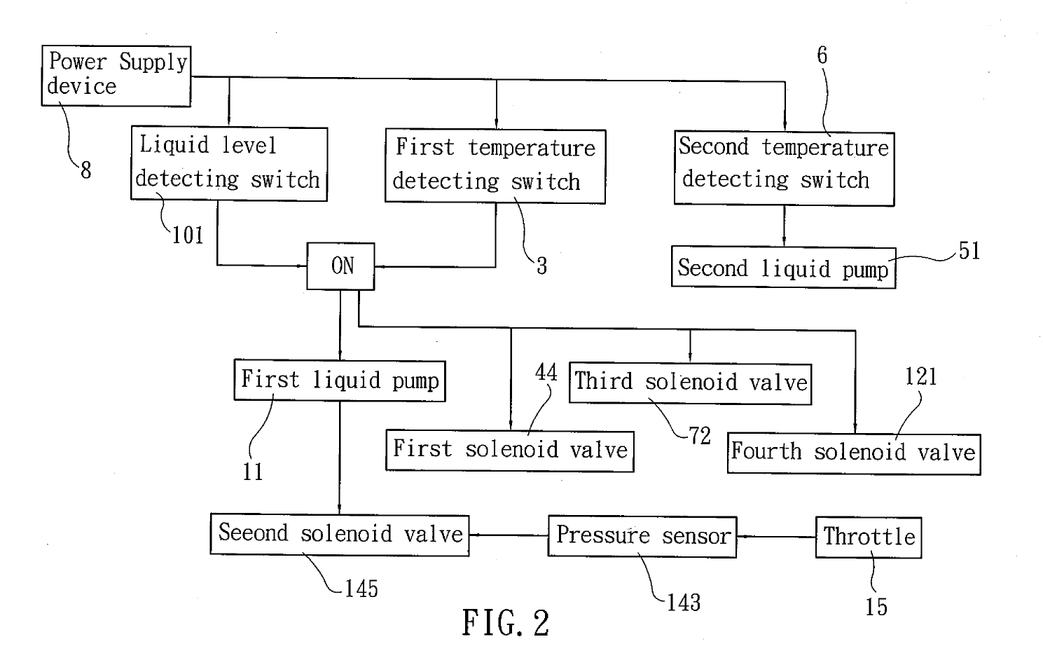

As shown in FIG. 2, electric power supplied by a power supply device 8 comes from a battery device provided on a car.

In an actuating circuit for the first liquid pump 11, there is a liquid level detecting switch 101. The actuating circuit for the first liquid pump 11 is cut off when the liquid level detecting switch 101 detects that the methanol-water solution in the methanol-water solution tank 10 is insufficient.

The coolant can be water or heat-resistant oil or other heat-resistant liquid. In the preferred embodiment of the present invention, the coolant is a type of heat-resistant oil. When the temperature of the catalytic converter 2 exceeds the preset safe temperature of 280° C., the second liquid pump 51 is actuated to supply the coolant to the cooling ducts 23 in the catalyst bed 20. The coolant passes through the cooling ducts 23 to cool the catalytic converter 2 and then flows back to the storage tank 50. The cooler 54 dissipates heat via air cooling. That is, when the car moves at high speed, the cold ambient air exchanges heat with the coolant flowing through the cooler 54. Alternatively, the cooling fan 541 can be used to dissipate heat and accordingly speed the cooling.

Hydrogen gas is highly active and burns quickly. While hydrogen can help in the complete combustion of the fuel to largely reduce the exhaust pollution, it also tends to burn away other substances in the engine 13. For instance, in case the lubricant on the inner wall surfaces of the engine 13 is burned away, the piston and valves in the engine 13 would have the problem of unsmooth movement. Thus, the hydrogenation system according to the present invention further includes a lubricant adding unit 7, which includes a lubricant tank 70, a lubricant conveying pipeline 71, and a normally closed third solenoid valve 72 provided on the lubricant conveying pipeline 71. When the actuating circuit for the first liquid pump 11 is made, the third solenoid valve 72 is actuated to open the lubricant conveying pipeline 71, so that the lubricant is output from the lubricant tank 70 at regular intervals and in fixed quantity and is jetted along with a fuel-air mixture into the engine 13 via a fuel/air nozzle (not shown) on the engine 13 for providing lubrication needed in piston movement and protection to the nozzle and valves. The quantity of lubricant output each time and the time interval between two supplies of lubricant can be set according to actual need.

The present invention can be used to supply hydrogen gas into an engine to help in full combustion of a fuel in the engine to achieve the purpose of reducing air pollution by exhaust emission from the engine. Further, with the present invention, lean fuel mixture with high air-fuel ratio can be hydrogenated to avoid engine detonation and save fuel.

The catalytic converter 2 has a working temperature as high as 220° C. (the working temperature can be differently set according to different type of catalysts 24). When the engine 13 is initially started or when the engine 13 is in an idle state, the temperature in the engine is lower than the working temperature of the hydrogen-producing catalysts 24 and the production of hydrogen might not be actuated to supply hydrogen gas into the engine to achieve the purposes of reducing air pollution and saving fuel. To overcome this problem, the hydrogenation system for internal combustion engine according to a third preferred embodiment of the present invention uses a different catalytic converter 2′.

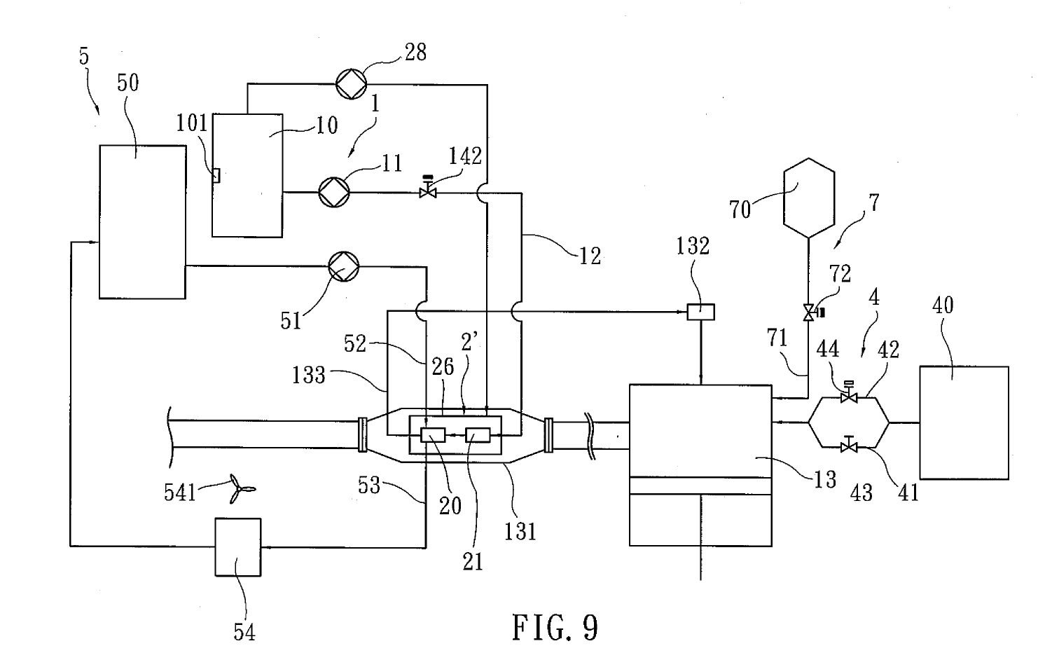

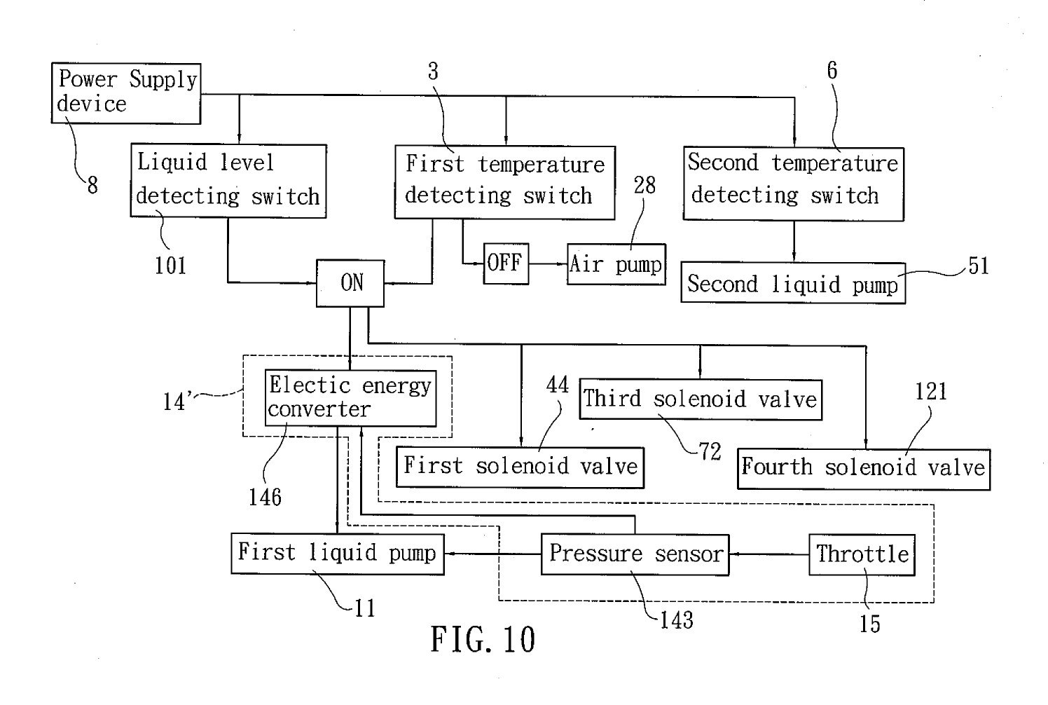

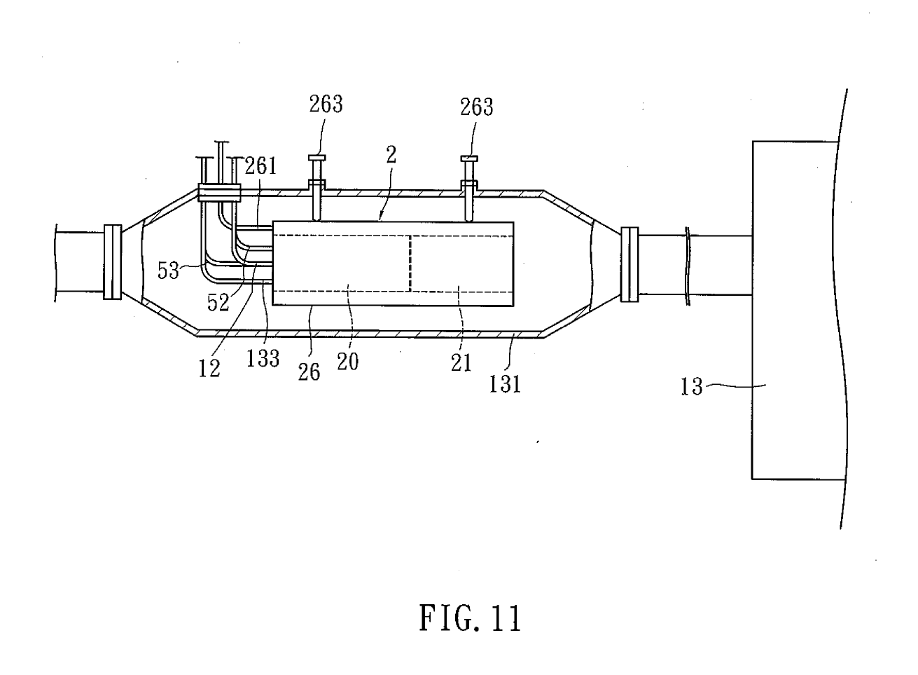

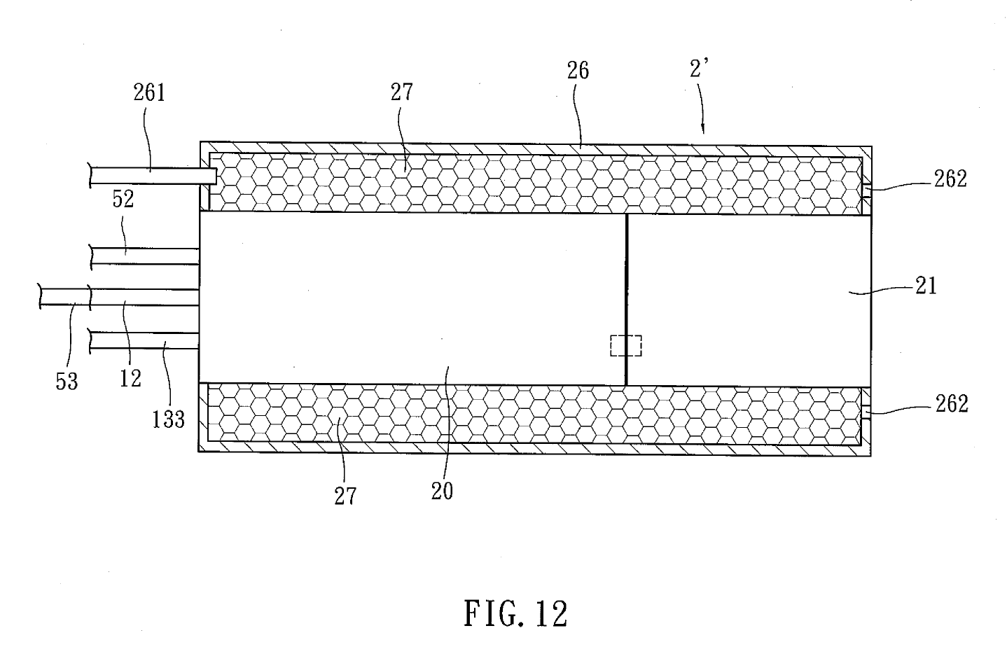

FIG. 9 is a conceptual diagram illustrating the structure of the third embodiment of the hydrogenation system; FIG. 10 is a block diagram showing the control circuit included in the hydrogenation system of FIG. 9; FIG. 11 is an enlarged, fragmentary and partial sectional view of FIG. 9 showing the installation of the catalytic converter 2′ in the exhaust pipe 131; and FIG. 12 is an enlarged sectional view of the catalytic converter 2′ shown in FIG. 11. The catalytic converter 2′ includes a catalyst bed 20, a preheating body 21, a heating pipe 26, and a plurality of heating catalysts 27 provided in the heating pipe 26. The heating catalysts 27 can be platinum catalysts. The heating pipe 26 is externally fitted around the preheating body 21 and the catalyst bed 20 with the heating catalysts 27 filled between the heating pipe 26 and the preheating body 21 and the catalyst bed 20. The heating pipe 26 has two sealed ends. A pipeline 261 is connected to one end of the heating pipe 26 to communicate the heating pipe 26 with a combustion gas tank 10 (i.e. the tank for storing the fuel-water solution), so that an oxygen-containing combustion gas can be supplied from the combustion gas tank 10 into the heating pipe 26 for heating the heating catalysts 27. The heated heating catalysts 27 in turn heat the catalyst bed 20 and the preheating body 21 to the working temperature of the hydrogen-producing catalysts 24. The oxygen-containing combustion gas is pumped into the heating pipe 26 by an air pump 28. The other end of the heating pipe 26 is provided with pressure relief vents 262. The preheating body 21 and the catalyst bed 20 can be welded together to form an integral body, which can be more easily installed into the heating pipe 26. The air pump 28 stops delivering the oxygen-containing combustion gas when the catalyst bed 20 is heated by the heating catalysts 27 in the heating pipe 26 to the working temperature of the hydrogen-producing catalysts 24. The combustion gas can be methanol steam stored in the tank 10.

The air pump 28 can be actuated with only very low power without causing too much power consumption. With the third preferred embodiment of the present invention, the first temperature detecting switch 3 can detect the catalysts 24 at their working temperature of 220° C. as soon as the car is started, and the methanol-water solution can be immediately delivered to the catalytic converter 2′ to enable subsequent supply of hydrogen gas into the engine 13. On the other hand, with the third embodiment of the present invention, the catalyst bed 20 can also maintain at a temperature more than 220° C. for the hydrogenation system to work even when the car is idling. Therefore, with the present invention, the hydrogenation system can work during the whole course of car driving to fully achieve the purposes of reducing air pollution and saving fuel.

The exhaust pipe 131 is provided on around its wall near both front and rear ends thereof with at least three equally angularly spaced screws 263, which radially extend into the exhaust pipe 131 to press against front and rear end portions of the heating pipe 26, so that the heating pipe 26 is fixedly held in the exhaust pipe 131 by the screws 263.

The hydrogenation system for internal combustion engine according to the present invention can be applied to various types of combustion engines, such as car engine, generator engine and the like, to fully achieve the functions of saving fuel and reducing air pollution. The hydrogenation system of the present invention can add hydrogen gas to lean fuel with high air-fuel ratio to avoid engine detonation and save fuel. Therefore, the hydrogenation system of the present invention is ideal and practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A hydrogenation system for internal combustion engine, comprising:
a fuel-water solution supply unit including a tank, a first liquid pump, and a conveying pipeline; the tank storing an amount of a fuel-water solution therein, and the stored fuel-water solution being pumped out from the tank by the first liquid pump to flow through the conveying pipeline;
a catalytic converter being arranged inside an exhaust pipe of the internal combustion engine to absorb heat in the engine's exhaust gas; the catalytic converter being communicable with the conveying pipeline of the fuel-water solution supply unit; the catalytic converter including a catalyst bed, a preheating body, a heating pipe, and a plurality of heating catalysts provided in the heating pipe; the fuel-water solution being heated and vaporized into steam by the preheating body and then delivered into the catalyst bed; the catalyst bed being internally provided with molecular rearrangement ducts and cooling ducts, and the molecular rearrangement ducts having hydrogen-producing catalysts provided therein for rearranging molecules in the vaporized fuel-water solution to produce hydrogen gas and carbon dioxide gas; the heating pipe being externally fitted around the preheating body and the catalyst bed with the heating catalysts filled between the heating pipe and the preheating body and the catalyst bed; the heating pipe having two sealed ends and being communicable with a combustion gas tank via an inlet pipe connected to one end of the heating pipe, so that a type of oxygen-containing combustion gas is supplied from the combustion gas tank into the heating pipe via the inlet pipe for heating the heating catalysts, which in turn heat the catalyst bed and the preheating body to a working temperature of the hydrogen-producing catalysts; and the other end of the heating pipe being provided with pressure relief vents;
a first temperature detecting switch for detecting a temperature of the catalytic converter and actuating the first liquid pump when the catalytic converter is detected as having a temperature reaching the working temperature of the hydrogen-producing catalysts, so that the fuel-water solution is supplied into the catalytic converter for producing hydrogen gas; and the produced hydrogen gas flowing through an engine intake manifold into the engine and then being burned along with a fuel in the engine when the latter is ignited;
a fuel supply control unit including two fuel feed pipes for supplying the fuel into the engine; the first fuel feed pipe being provided with a manual control valve and the second fuel feed pipe being provided with a normally open first solenoid valve; and the first solenoid valve being actuated when the first liquid pump is actuated, so as to close the second fuel feed pipe and reduce the amount of fed fuel for the fuel and air in the engine to have a lowered fuel-air ratio;
a coolant supply unit including a storage tank, a second liquid pump and a coolant conveying pipeline; the storage tank storing an amount of coolant therein and the stored coolant being pumped out from the storage tank by the second liquid pump to flow through the coolant conveying pipeline; and the coolant conveying pipeline being provided with a heat-dissipation cooler, which exchanges heat with cold ambient air; and
a second temperature detecting switch for detecting a temperature of the catalytic converter and actuating the second liquid pump when the catalytic converter is detected as having a temperature reaching a safe temperature of the hydrogen-producing catalysts, so that the coolant is delivered into the cooling ducts in the catalyst bed to lower the latter's temperature.

2. The hydrogenation system for internal combustion engine as claimed in claim 1, wherein the fuel-water solution supply unit further includes a fuel-water solution supply control section, which includes a pressure sensor and an electric energy converter; the pressure sensor detecting a throttle's movement and generating different electric energy signals in response to different open degrees of the throttle, so as to drive the first liquid pump to pump out different amounts of the fuel-water solution from the tank.

3. The hydrogenation system for internal combustion engine as claimed in claim 2, wherein the electric energy converter is a pulse-width modulator (PWM).

4. The hydrogenation system for internal combustion engine as claimed in claim 1, wherein the fuel-water solution supply unit further includes a fuel-water solution supply control section, which includes a first and a second feed pipe for delivering the fuel-water solution, and a pressure sensor for detecting pressure applied to a throttle; the first feed pipe being provided with a manual control valve and the second feed pipe being provided with a normally closed second solenoid valve; the second solenoid valve being actuated when the pressure sensor detects the throttle is in a stably opened state, so as to open the second feed pipes to increase the amount of the fuel-water solution being supplied to the catalytic converter.

5. The hydrogenation system for internal combustion engine as claimed in claim 1, wherein the fuel-water solution is methanol-water solution; and wherein the working temperature and the safe temperature of the catalysts in the catalytic converter are set to 220° C. and 280° C., respectively.

6. The hydrogenation system for internal combustion engine as claimed in claim 5, wherein the catalysts in the catalytic converter are CUZn-based catalysts.

7. The hydrogenation system for internal combustion engine as claimed in claim 1, wherein the fuel-water solution supply unit includes a liquid level detecting switch; and an actuating circuit for the first liquid pump being cut off when the liquid level detecting switch detects that the fuel-water solution in the tank is insufficient.

8. The hydrogenation system for internal combustion engine as claimed in claim 1, further comprising a lubricant adding unit, which includes a lubricant tank, a lubricant conveying pipeline, and a normally closed third solenoid valve provided on the lubricant conveying pipeline; whereby when an actuating circuit for the first liquid pump is made, the third solenoid valve is periodically actuated, so that lubricant is output from the lubricant tank into the engine via the lubricant conveying pipeline at regular intervals and in fixed quantity.

9. The hydrogenation system for internal combustion engine as claimed in claim 1, wherein the oxygen-containing combustion gas is supplied from the combustion gas tank into the heating pipe by an air pump.

10. The hydrogenation system for internal combustion engine as claimed in claim 9, wherein the air pump stops supplying the oxygen-containing combustion gas when the catalyst bed is heated by the heating catalysts in the heating pipe to the working temperature of the hydrogen-producing catalysts.

11. The hydrogenation system for internal combustion engine as claimed in claim 1, wherein the combustion gas is methanol steam.

12. The hydrogenation system for internal combustion engine as claimed in claim 1, wherein the heating catalysts in the heating pipe are platinum catalysts.

13. A hydrogenation system for internal combustion engine, comprising:
a fuel-water solution supply unit including a tank, a first liquid pump, and a conveying pipeline; the tank storing an amount of a fuel-water solution therein, and the stored fuel-water solution being pumped out from the tank by the first liquid pump to flow through the conveying pipeline;
a catalytic converter being arranged inside an exhaust pipe of the internal combustion engine to absorb heat in the engine's exhaust gas; the catalytic converter being communicable with the conveying pipeline of the fuel-water solution supply unit; the catalytic converter including a catalyst bed and a preheating body; the fuel-water solution being heated and vaporized into steam by the preheating body and then delivered into the catalyst bed; the catalyst bed being internally provided with molecular rearrangement ducts and cooling ducts, and the molecular rearrangement ducts having hydrogen-producing catalysts provided therein for rearranging molecules in the vaporized fuel-water solution to produce hydrogen gas and carbon dioxide gas;
a first temperature detecting switch for detecting a temperature of the catalytic converter and actuating the first liquid pump when the catalytic converter is detected as having a temperature reaching the working temperature of the hydrogen-producing catalysts, so that the fuel-water solution is supplied into the catalytic converter for producing hydrogen gas; and the produced hydrogen gas flowing through an engine intake manifold into the engine and then being burned along with a fuel in the engine when the latter is ignited;
a fuel supply control unit including two fuel feed pipes for supplying the fuel into the engine; the first fuel feed pipe being provided with a manual control valve and the second fuel feed pipe being provided with a normally open first solenoid valve; and the first solenoid valve being actuated when the first liquid pump is actuated, so as to close the second fuel feed pipe and reduce the amount of fed fuel for the fuel and air in the engine to have a lowered fuel-air ratio;
a coolant supply unit including a storage tank, a second liquid pump and a coolant conveying pipeline; the storage tank storing an amount of coolant therein and the stored coolant being pumped out from the storage tank by the second liquid pump to flow through the coolant conveying pipeline; and the coolant conveying pipeline being provided with a heat-dissipation cooler, which exchanges heat with cold ambient air; and
a second temperature detecting switch for detecting a temperature of the catalytic converter and actuating the second liquid pump when the catalytic converter is detected as having a temperature reaching a safe temperature of the hydrogen-producing catalysts, so that the coolant is delivered into the cooling ducts in the catalyst bed to lower the latter's temperature.

14. The hydrogenation system for internal combustion engine as claimed in claim 13, wherein the fuel-water solution supply unit further includes a fuel-water solution supply control section, which includes a pressure sensor and an electric energy converter; the pressure sensor detecting a throttle's movement and generating different electric energy signals in response to different open degrees of the throttle, so as to drive the first liquid pump to pump out different amounts of the fuel-water solution from the tank.

15. The hydrogenation system for internal combustion engine as claimed in claim 14, wherein the electric energy converter is a pulse-width modulator (PWM).

16. The hydrogenation system for internal combustion engine as claimed in claim 13, wherein the fuel-water solution supply unit further includes a fuel-water solution supply control section, which includes a first and a second feed pipe for delivering the fuel-water solution, and a pressure sensor for detecting pressure applied to a throttle; the first feed pipe being provided with a manual control valve and the second feed pipe being provided with a normally closed second solenoid valve; the second solenoid valve being actuated when the pressure sensor detects the throttle is in a stably opened state, so as to open the second feed pipes to increase the amount of fuel-water solution being supplied to the catalytic converter.

17. The hydrogenation system for internal combustion engine as claimed in claim 13, wherein the fuel-water solution is methanol-water solution; and wherein the working temperature and the safe temperature of the catalysts in the catalytic converter are set to 220° C. and 280° C., respectively.

18. The hydrogenation system for internal combustion engine as claimed in claim 17, wherein the catalysts in the catalytic converter are CUZn-based catalysts.

19. The hydrogenation system for internal combustion engine as claimed in claim 13, wherein the fuel-water solution supply unit includes a liquid level detecting switch; and an actuating circuit for the first liquid pump being cut off when the liquid level detecting switch detects that the fuel-water solution in the tank is insufficient.

20. The hydrogenation system for internal combustion engine as claimed in claim 13, further comprising a lubricant adding unit, which includes a lubricant tank, a lubricant conveying pipeline, and a normally closed third solenoid valve provided on the lubricant conveying pipeline; whereby when an actuating circuit for the first liquid pump is made, the third solenoid valve is periodically actuated, so that lubricant is output from the lubricant tank into the engine via the lubricant conveying pipeline at regular intervals and in fixed quantity.
